(19) United States
(12) Patent Application Publication
(10) Pub. No.: US 2026/0288082 A1
(43) Pub. Date: Sep. 24, 2026

(54) VOLTAGE CONTROL CIRCUIT, ELECTRONIC TIMEPIECE

(71) Applicant: CITIZEN WATCH CO., LTD., Tokyo (JP)

(72) Inventor: Masahiko HITOMI, Iruma-shi (JP)

(21) Appl. No.: 19/570,155

(22) Filed: Mar. 18, 2026

(30) Foreign Application Priority Data
Mar. 19, 2025 (JP) 2025-045314

(51) Int. Cl. G04G 19/02; G05F 1/575; G05F 1/59

(52) U.S. Cl. CPC G04G 19/02; G05F 1/575; G05F 1/59

(57) ABSTRACT

A voltage control circuit includes output circuit for outputting an output voltage, feedback circuit for controlling the output voltage to be a target voltage based on a difference between a predetermined reference voltage and the output voltage, and switching circuit for supplying an additional current to the output circuit in addition to a predetermined constant current and switching the output voltage from a first output voltage to a second output voltage higher than the first output voltage. When switching the output voltage from the first output voltage to the second output voltage, the switching circuit continuously varies the additional current supplied to the output circuit.

### CROSS-REFERENCE TO RELATED APPLICATION

The present application claims priority from Japanese application No. 2025-045314 filed on Mar. 19, 2025, the content of which is hereby incorporated by reference into this application.

### BACKGROUND OF THE INVENTION

### 1. Field of the Invention

The present invention relates to a voltage control circuit and an electronic timepiece.

### 2. Description of the Related Art

JP2015-169600A discloses a regulator circuit capable of selectively outputting multiple voltage levels.

For example, in the circuit configuration disclosed in FIG. 13 of JP2015-169600A, when PMOSFET 1308 is turned on, the impedance at the feedback-side input of the differential amplifier circuit decreases sharply, and the corresponding input voltage is pulled up toward VDD because the drain current of PMOSFET 1308 is added to the current flowing through PMOSFET 1307. When the differential amplifier circuit momentarily performs feedback control to pull the feedback-side input voltage back, the voltage at the VREG terminal drops sharply toward VSS. As a result, when the switch is changed to output a higher level of constant voltage, the voltage temporarily drops significantly (undershoot), which may lead to malfunction of the circuit.

One or more embodiments of the present invention have been conceived in view of the above, and an object thereof is to provide a voltage control circuit and an electronic timepiece capable of stably switching output voltages.

### SUMMARY OF THE INVENTION

The invention disclosed in the present application in order to solve the above problem has various aspects, and a summary of representative of those aspects is as follows.
(1) A voltage control circuit includes output circuit for outputting an output voltage, feedback circuit for controlling the output voltage to be a target voltage based on a difference between a predetermined reference voltage and the output voltage, and switching circuit for supplying an additional current to the output circuit in addition to a predetermined constant current and switching the output voltage from a first output voltage to a second output voltage higher than the first output voltage. When switching the output voltage from the first output voltage to the second output voltage, the switching circuit continuously varies the additional current supplied to the output circuit.
(2) In (1), the switching circuit includes a capacitor and an additional current adjusting unit that supplies, to the output circuit, the additional current that continuously varies in accordance with a switching voltage increasing with a discharge current generated by discharge of the capacitor.
(3) In (2), the switching circuit includes a current control unit provided in a path through which the discharge current flows and configured to control an amount of the discharge current.
(4) In (3), the current control unit is a constant current source that keeps the discharge current constant and causes the switching voltage to linearly increase.
(5) In (3), the current control unit is a resistive element.
(6) In any of (2) to (5), the additional current adjusting unit starts supplying the additional current when the switching voltage reaches or exceeds a predetermined voltage, and the switching circuit includes a current path in which the discharge current is increased until the switching voltage reaches the predetermined voltage.
(7) In any of (2) to (6), the switching circuit causes the discharge current of a first current amount to flow when the switching voltage does not reach a predetermined voltage, and causes the discharge current of a second current amount smaller than the first current amount to flow when the switching voltage reaches the predetermined voltage.
(8) In (6) or (7), the switching voltage increases toward a power supply voltage in accordance with the discharge current, and, after switching from the first output voltage to the second output voltage is completed, the switching circuit sets the switching voltage to the power supply voltage before the switching voltage, which increases in accordance with the discharge current, reaches the power supply voltage.
(9) In any of (2) to (8), the additional current adjusting unit is a MOS transistor that includes a gate to which the switching voltage is applied.
(10) An electronic timepiece includes the voltage control circuit according to any one of (1) to (9) and a clock circuit that is driven by the output voltage.

### BRIEF DESCRIPTION OF THE DRAWINGS

FIG. 1 is a circuit diagram illustrating a voltage control circuit according to the present embodiment;

FIG. 2 is a timing chart showing an operation of the voltage control circuit according to the present embodiment;

FIG. 3 is a circuit diagram illustrating a switching unit of the voltage control circuit according to the first modified example;

FIG. 4 is a timing chart showing the operation of the voltage control circuit according to the first modified example;

FIG. 5 is a circuit diagram illustrating a switching unit of the voltage control circuit according to the second modified example; and

FIG. 6 is a timing chart showing the operation of the voltage control circuit according to the second modified example.

### DETAILED DESCRIPTION OF THE INVENTION

Embodiment of the present invention (hereinafter, referred to as “present embodiment”) will be described below in detail with reference to the accompanying drawings.

### Outline of Voltage Control Circuit

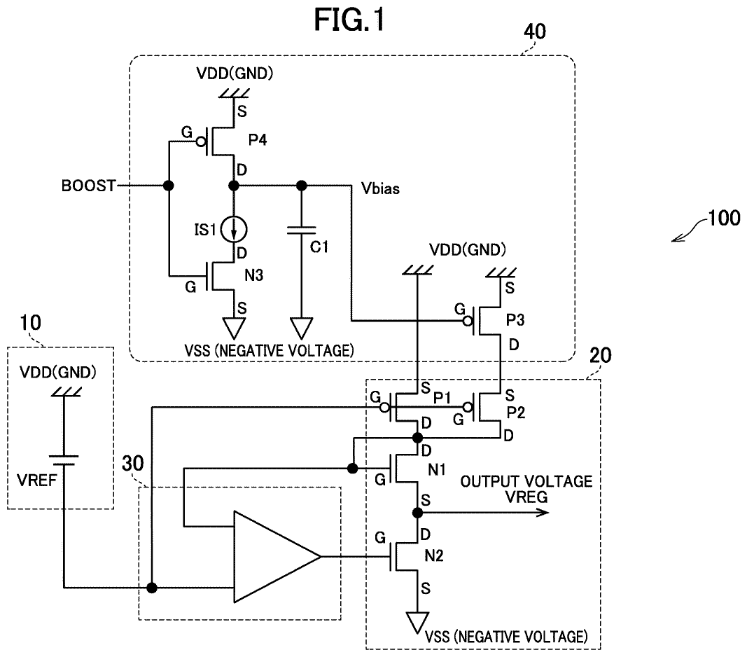

FIG. 1 is a circuit diagram illustrating a voltage control circuit according to the present embodiment. The voltage control circuit 100 is a circuit capable of switching the output voltage VREG between a first output voltage VREG1 and a second output voltage VREG2. The first output voltage VREG1 and the second output voltage VREG2 are both constant voltages, and the second output voltage VREG2 is higher than the first output voltage VREG1. The voltage control circuit 100 is configured to perform feedback control so as to maintain the output voltage VREG at a target value.

When the output voltage is switched, a temporary and significant drop in voltage (undershoot) may occur, which can lead to malfunction of the circuit. In view of this, the present embodiment uses a configuration in which a load current IL supplied to the load when switching the output voltage VREG is gradually changed, thereby reducing the occurrence of undershoot.

A negative power supply is used in the voltage control circuit 100. As such, VDD in FIG. 1 represents the ground voltage (0V), and VSS represents the negative voltage. The magnitude of the voltage refers to the magnitude of its absolute value.

### Configuration of Voltage Control Circuit

The voltage control circuit 100 includes a reference voltage generating unit 10, an output unit 20, a feedback unit 30, and a switching unit 40.

The reference voltage generating unit 10 includes a reference voltage source and generates a reference voltage VREF.

The output unit 20 may be a regulator circuit that outputs an output voltage VREG, which is a constant voltage. The output unit 20 includes PMOS transistors P1 and P2, and NMOS transistors N1 and N2.

The transistor P1 functions as a current source and controls the load current IL. The source S of the transistor P1 is connected to VDD (0V), and the drain D of the transistor P1 is connected to the transistor N1.

The transistor P2 functions as a current source and controls the load current IL. The source S of the transistor P2 is connected to the transistor P3, and the drain D of the transistor P2 is connected to the transistor N1.

The source S of the transistor N1 is connected to the load, and the drain D of the transistor N1 is connected to the drain D of the transistor P1 and the drain D of the transistor P2.

The source S of the transistor N2 is connected to VSS (negative voltage), and the drain D of the transistor N2 is connected to the load.

The feedback unit 30 detects a difference between the reference voltage VREF and the current output voltage VREG, and adjusts the input to the gate G of the transistor N2 so as to regulate the output voltage VREG to the target value.

The switching unit 40 is a circuit that switches the output voltage VREG output from the output unit 20 between the first output voltage and the second output voltage. The switching unit 40 may be a boost bias circuit.

The switching unit 40 controls the output voltage VREG based on a control signal BOOST output from a control circuit (not shown). When BOOST is Low, the switching unit 40 maintains the output voltage VREG at the first output voltage, and when BOOST is High, the switching unit 40 switches the output voltage VREG to the second output voltage.

The switching unit 40 includes PMOS transistors P3 and P4, an NMOS transistor N3, a capacitor C1, and a constant current source IS1 serving as a current control unit.

The transistor P3 functions as an additional current adjusting unit that supplies to the output unit 20 an additional current I2 that continuously varies in accordance with a bias voltage Vbias, which is a switching voltage that increases with a discharge current generated by the discharge of the capacitor C1. In this regard, “an additional current I2 that continuously varies” means that the additional current I2 gradually changes over time, and may also include cases where the additional current I2 changes in a stepwise manner during certain periods. The source S of the transistor P3 is connected to VDD (0V), and the drain D of the transistor P3 is connected to the transistor P2.

The source S of the transistor P4 is connected to VDD (0V). The drain D of the transistor P4 is connected to the constant current source IS1, the capacitor C1, and the gate G of the transistor P3. The source S of the transistor N3 is connected to VSS (negative voltage), and the drain D of the transistor N3 is connected to the constant current source IS1.

The constant current source IS1 is provided in a path through which a discharge current generated by the discharge of the capacitor C1 flows, and keeps the discharge current constant so as to linearly increase the bias voltage Vbias. In this regard, “linearly increase” does not exclude increases that partially include nonlinear portions. That is, increases that are nearly linear are also included.

### Operation of Voltage Control Circuit

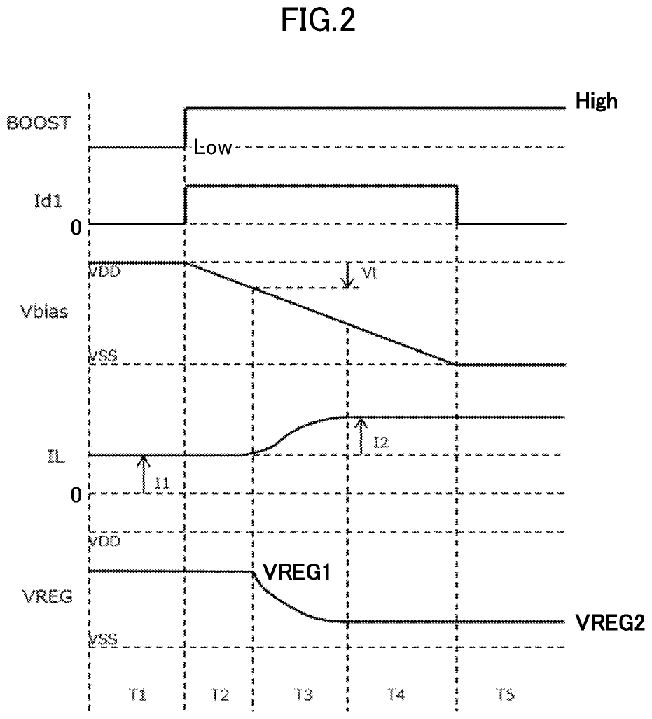

Next, referring to FIGS. 1 and 2, the operation of the voltage control circuit 100 according to the present embodiment will be described. FIG. 2 is a timing chart showing the operation of the voltage control circuit according to the present embodiment.

In the voltage control circuit 100, the switching from the first output voltage VREG1 to the second output voltage VREG2 is completed through the initial period T1, the switching start period T2, the output voltage change period T3, the period before completion of the bias voltage change T4, and the period after completion of the bias voltage change T5.

During the initial period T1, the output voltage VREG remains at the first output voltage VREG1. Further, the transistors P3 and N3 are OFF during the initial period T1. In this state, capacitor C1 is charged by VDD (0 V). Further, the bias voltage Vbias is VDD (0 V).

During the initial period T1, the constant current I1 is supplied to the output unit 20 through the transistor P1. In this state, the load current IL is equal to I1. As a result, the output voltage VREG is at the level of the first output voltage VREG1.

The switching start period T2 is a period after the control signal BOOST supplied to the switching unit 40 is switched from Low to High. This switching turns the transistor P4 OFF and the transistor N3 ON. When the transistor P4 turns OFF, the charge path of the capacitor C1 through the transistor P4 is blocked. When the transistor N3 turns ON, a discharge path of the capacitor C1 is formed, and the discharge of the capacitor C1 begins. As a result, a constant current Id1 from the constant current source IS1 flows into the drain D of the transistor N3, and the charge of the capacitor C1 is gradually reduced. Consequently, the bias voltage Vbias applied to the gate G of the transistor P3 changes toward VSS (negative voltage).

During the switching start period T2, the change in the bias voltage Vbias toward VSS is small, and the transistor P3 therefore remains in the OFF state.

The output voltage change period T3 is a period immediately after the output voltage VREG begins to change toward VSS. When the change in the bias voltage Vbias toward VSS exceeds a certain value (Vt), the additional current I2 gradually begins to flow through the transistor P3. As a result, the load current IL supplied to the output unit 20 gradually increases from I1. The output voltage VREG gradually changes from the first output voltage VREG1 toward the second output voltage VREG2.

The period before completion of the bias voltage change T4 is a period after the output voltage change period T3, during which the bias voltage Vbias changes toward VSS. The period after completion of the bias voltage change T5 is a period after the bias voltage Vbias has reached VSS (negative voltage), during which the discharge of capacitor C1 has been completed.

### Conclusion of Embodiment

In the voltage control circuit 100 according to the present embodiment, a circuit configuration that gradually increases the load current IL is employed, thereby reducing a temporary and significant drop in the output voltage VREG. As a result, stable circuit operation can be achieved.

### First Modified Example

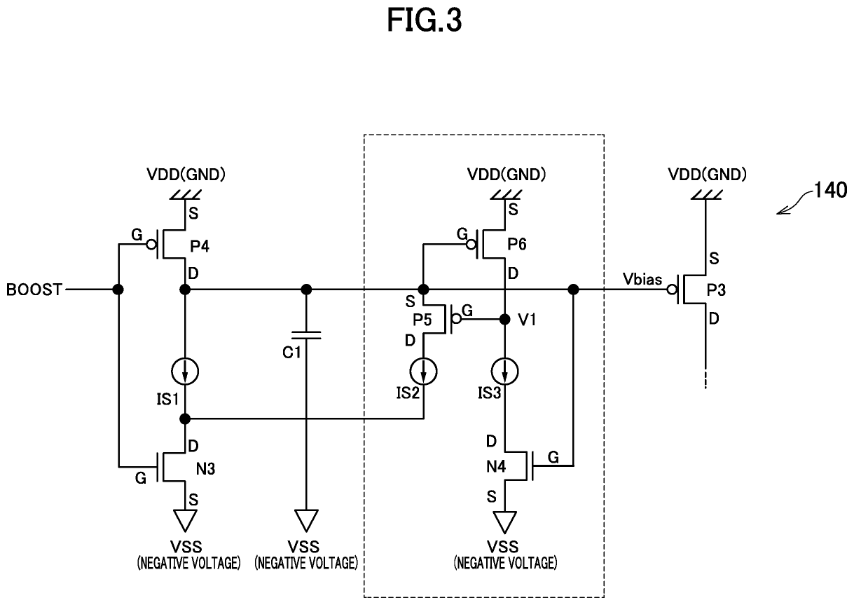

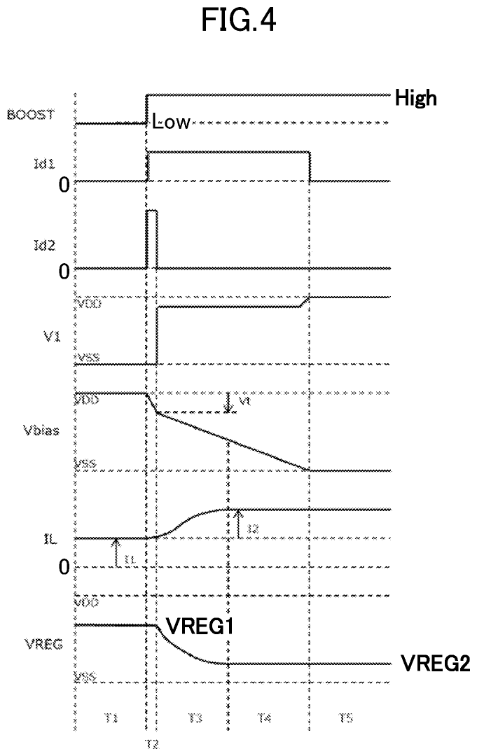

Next, referring to FIGS. 3 and 4, a voltage control circuit according to a first modified example of the present embodiment will be described. FIG. 3 is a circuit diagram illustrating a switching unit of the voltage control circuit according to the first modified example. FIG. 4 is a timing chart of the voltage control circuit according to the first modified example.

In the first modified example, the configurations of the reference voltage generating unit 10, the output unit 20, and the feedback unit 30 are the same as those shown in FIG. 1 and are therefore not shown. Further, the same reference numerals are used for components having the same functions as those in FIG. 1.

The switching unit 140 further includes components within the dashed lines in FIG. 3, in addition to the components of the switching unit 40 shown in FIG. 1. Specifically, the switching unit 140 includes a transistor N4, a transistor P5, a transistor P6, a constant current source IS2, and a constant current source IS3.

The first modified example employs the configuration including the constant current source IS2 and the constant current source IS3, and this makes it possible to shorten the time, after the control signal BOOST supplied to the switching unit 40 switches from Low to High, for the change in the bias voltage Vbias toward VSS to reach a predetermined value (Vt). As a result, the switching of the output voltage VREG can be performed more quickly than in the configuration of the present embodiment. In the following, the details of the circuit configuration and its operation in the first modified example will be described.

The source S of the transistor N4 is connected to VSS (negative voltage), and the drain D of the transistor N4 is connected to the constant current source IS3.

The source S of the transistor P5 is connected to the gate G of the transistor P6, the gate G of the transistor P3, the gate G of the transistor N4, the drain D of the transistor P4, the constant current source IS1, and the capacitor C1. The drain D of the transistor P5 is connected to the constant current source IS2. Further, the drain D of the transistor N3 is connected to the constant current source IS1 and the constant current source IS2.

The source S of transistor P6 is connected to VDD (0 V), and the drain D of transistor P6 is connected to the constant current source IS3. As such, when BOOST is Low, transistor P6 is OFF and transistor N4 is ON. With transistor N4 is ON, transistor P5 is ON because its gate G is at VSS (negative voltage).

In the first modified example, similarly to the present embodiment, the switching from the first output voltage VREG1 to the second output voltage VREG2 is completed through the initial period T1, the switching start period T2, the output voltage change period T3, the period before completion of the bias voltage change T4, and the period after completion of the bias voltage change T5.

During the initial period T1, the output voltage VREG remains at the first output voltage VREG1. Further, during the initial period T1, the transistors P3, N3, and P6 are OFF. In this state, the capacitor C1 is charged by VDD (0V). Further, the bias voltage Vbias is VDD (0V).

The switching start period T2 is a period after the control signal BOOST supplied to the switching unit 40 is switched from Low to High. This switching turns the transistor P4 OFF and the transistor N3 ON. As the capacitor C1 discharges, a constant current Id1 from the constant current source IS1 and a discharge current Id2 from the constant current source IS2 flow into the drain D of the transistor N3. Compared with the configuration described with reference to FIG. 1, the bias voltage Vbias supplied to the gate G of the transistor P3 changes more rapidly toward VSS (negative voltage) because a constant current discharge is performed by the constant current source IS2.

FIG. 3 is merely an example, and the switching unit 140 may have any configuration if it includes a current path in which the discharge current from the capacitor C1 is increased until the bias voltage Vbias reaches a predetermined voltage. In this example, the discharge current Id2 is made larger than the constant current Id1 so that the bias voltage Vbias can change more rapidly, although the magnitude relationship between the constant current Id1 and the discharge current Id2 is not limited to this.

The output voltage change period T3 is a period immediately after the output voltage VREG begins to change toward VSS. In the first modified example, the switching start period T2 is short, and therefore the output voltage change period T3 occurs earlier. During the output voltage change period T3, the load current IL supplied to the output unit 20 gradually increases from I1. The output voltage VREG gradually changes from the first output voltage VREG1 toward the second output voltage VREG2.

In the first modified example, after the output voltage change period T3, the constant current of the constant current source IS3 is set to be smaller than the drain current of the transistor P6. As a result, the gate potential V1 of the transistor P5 shifts to VDD (0V). This potential change causes the transistor P5 to turn OFF, thereby interrupting the current path and stopping the discharge by the constant current source IS2. As a result, the gate voltage of the transistor P3 changes, and the supply of the additional current I2 begins. Consequently, the load current IL increases, and the output voltage VREG continues to change toward VSS.

The period before completion of the bias voltage change T4 is a period after the output voltage change period T3, during which the bias voltage Vbias changes toward VSS. When the bias voltage Vbias approaches VSS (negative voltage), the transistor N4 turns OFF, and the gate potential V1 of the transistor P5 reaches VDD (0V).

The period after completion of the bias voltage change T5 is a period after the bias voltage Vbias has reached VSS (negative voltage), during which the discharge of capacitor C1 has been completed. During this period, the transistor N4 is ensured to be OFF, and the current path of the constant current source IS3 is interrupted. This helps to reduce unnecessary power consumption.

In the first modified example, the switching unit 140 includes the constant current source IS1 that linearly increases the bias voltage Vbias by keeping the discharge current from the capacitor constant, but the invention is not limited to this example. The current control unit may be implemented as a resistive element. In this case, the discharge current starts at an initial value of Id2=(VDD−VSS)/R and then decays exponentially. As a result, the bias voltage Vbias changes non-linearly toward VSS. Similarly, in the second modified example described later, a resistive element may be used instead of the constant current source IS1.

### Second Modified Example

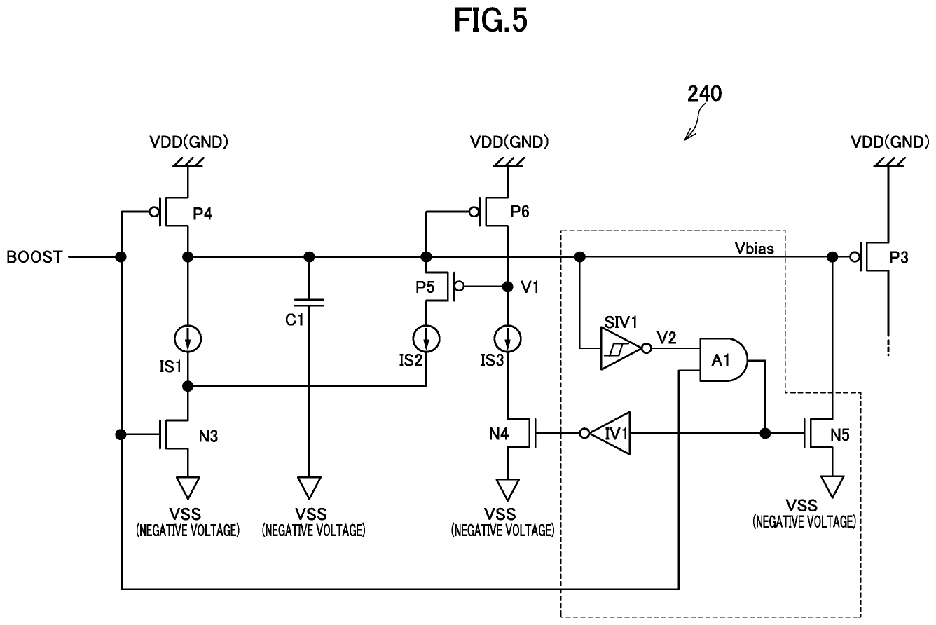

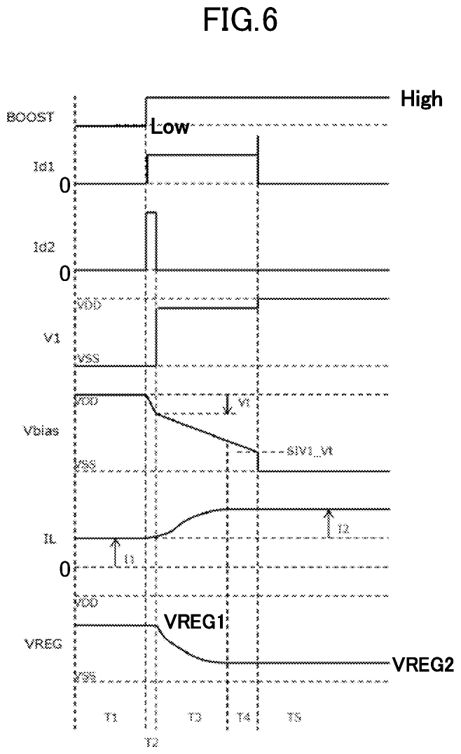

Next, referring to FIGS. 5 and 6, a voltage control circuit according to a second modified example of the present embodiment will be described. FIG. 5 is a circuit diagram illustrating a switching unit of the voltage control circuit according to the second modified example. FIG. 6 is a timing chart of the voltage control circuit according to the second modified example.

In the second modified example, the configurations of the reference voltage generating unit 10, the output unit 20, and the feedback unit 30 are the same as those shown in FIG. 1 and are therefore not shown. Further, the same reference numerals are used for components having the same functions as those in FIG. 1.

The switching unit 240 further includes components within the dashed lines in FIG. 5, in addition to the components of the switching unit 140 shown in FIG. 3. Specifically, the switching unit 240 includes a transistor N5, an inverter IV1, a Schmitt-trigger inverter SIV1, and an AND circuit A1.

In the second modified example, after the switching from the first output voltage VREG1 to the second output voltage VREG2 is completed, the bias voltage Vbias is forced to switch to VSS (negative voltage).

In the second modified example, when the bias voltage Vbias falls below the threshold voltage SIV1_Vt of the Schmitt-trigger inverter SIV1, the output V2 of the Schmitt-trigger inverter SIV1 changes from Low to High. As a result, the input conditions of the AND circuit A1 are satisfied, and the output voltage of the AND circuit A1 changes from Low to High. When the output voltage of the AND circuit A1 becomes High, the transistor N4 turns OFF, causing the transistor N5 to switch ON. As a result, a new discharge path is formed, and the bias voltage Vbias is rapidly pulled down to VSS (negative voltage) through the transistor N5. Consequently, the residual charge of the capacitor C1 is discharged in a short time, allowing the bias voltage Vbias to reach VSS (negative voltage) in a short time. This allows the voltage switching to be completed quickly, while reducing unnecessary power consumption and improving the stability of circuit operation.

### Others

The voltage control circuit 100 described in the present embodiment and the modified examples is particularly useful in electronic timepieces in which precise voltage control is required. For example, in a case where the voltage control circuit 100 is applied to an electronic timepiece, the output voltage VREG may be supplied to a clock circuit including a crystal oscillator circuit.

In the present embodiment and the modified examples, a negative power supply is used, but a positive power supply may alternatively be employed. In this case, the operation of the circuit can be stabilized by reducing the overshoot in the feedback control.

What is claimed is:

1. A voltage control circuit comprising:
output circuit for outputting an output voltage;
feedback circuit for controlling the output voltage to be a target voltage based on a difference between a predetermined reference voltage and the output voltage; and
switching circuit for supplying an additional current to the output circuit in addition to a predetermined constant current and switching the output voltage from a first output voltage to a second output voltage higher than the first output voltage, wherein
when switching the output voltage from the first output voltage to the second output voltage, the switching circuit continuously varies the additional current supplied to the output circuit.

2. The voltage control circuit according to claim 1, wherein
the switching circuit includes a capacitor and an additional current adjusting unit that supplies, to the output circuit, the additional current that continuously varies in accordance with a switching voltage increasing with a discharge current generated by discharge of the capacitor.

3. The voltage control circuit according to claim 2, wherein
the switching circuit includes a current control unit provided in a path through which the discharge current flows and configured to control an amount of the discharge current.

4. The voltage control circuit according to claim 3, wherein
the current control unit is a constant current source that keeps the discharge current constant and causes the switching voltage to linearly increase.

5. The voltage control circuit according to claim 3, wherein
the current control unit is a resistive element.

6. The voltage control circuit according to claim 2, wherein
the additional current adjusting unit starts supplying the additional current when the switching voltage reaches or exceeds a predetermined voltage, and
the switching circuit includes a current path in which the discharge current is increased until the switching voltage reaches the predetermined voltage.

7. The voltage control circuit according to claim 2, wherein
the switching circuit causes the discharge current of a first current amount to flow when the switching voltage does not reach a predetermined voltage, and causes the discharge current of a second current amount smaller than the first current amount to flow when the switching voltage reaches the predetermined voltage.

8. The voltage control circuit according to claim 6, wherein
the switching voltage increases toward a power supply voltage in accordance with the discharge current, and
after switching from the first output voltage to the second output voltage is completed, the switching circuit sets the switching voltage to the power supply voltage before the switching voltage, which increases in accordance with the discharge current, reaches the power supply voltage.

9. The voltage control circuit according to claim 2, wherein
the additional current adjusting unit is a MOS transistor that includes a gate to which the switching voltage is applied.

10. An electronic timepiece comprising:
output circuit for outputting an output voltage;
feedback circuit for controlling the output voltage to be a target voltage based on a difference between a predetermined reference voltage and the output voltage; and
switching circuit for supplying an additional current to the output circuit in addition to a predetermined constant current and switching the output voltage from a first output voltage to a second output voltage higher than the first output voltage, wherein
when switching the output voltage from the first output voltage to the second output voltage, the switching circuit continuously varies the additional current supplied to the output circuit; and
a clock circuit that is driven by the output voltage.
